(19) United States
(12) Patent Application Publication
(10) Pub. No.: US 2006/0164967 A1
(43) Pub. Date: Jul. 27, 2006

(54) Objective lens and optical pickup device

(76) Inventor: Kiyono Ikenaka, TOKYO (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 10/562,156

(22) PCT Filed: Mar. 25, 2005
(86) PCT No.: PCT/JP05/05489

§ 371 Date: Dec. 23, 2005

(30) Foreign Application Priority Data
Aug. 8, 2003 (JP) 2003-290741

(51) Int. Cl. G11B 15/64; G11B 17/32

(52) U.S. Cl. 369/300

(57) ABSTRACT

An objective lens is used for an optical pickup device that conducts reproducing of information by using a light flux with wavelength λ1 (370 nm≦λ1≦440) for the first optical disc having protective base board thickness t1 (0 mm≦t1≦0.2 mm) and the second optical disc having protective base board thickness t2 (t1<t2). On an optical surface of the objective lens, there is provided a first zone where transmitted light flux with wavelength λ1 is used for reproducing of information for the first and second optical discs, and when a third optical disc having protective base board thickness T (0.13 mm≦T≦0.25 mm) is assumed, it is possible to correct 3^{rd} order spherical aberration value SA3 generated when a light flux with wavelength λ1 passing through the first zone after entering the objective lens in parallel is converged on an information recording surface of the optical disc.

### FIELD OF THE INVENTION

The present invention relates to an objective lens and an optical pickup device.

### BACKGROUND OF THE INVENTION

In recent years, there has been advanced a trend toward a shorter wavelength of a laser light source used as a light source for reproducing of information recorded on an optical disc and for recording of information on an optical disc, and for example, there has been put to practical use a laser light source having wavelength of 405 nm such as a violet semiconductor laser and a violet SHG laser that converts a wavelength of an infrared semiconductor laser by using generation of the second harmonic.

If these violet laser light sources are used, when an objective lens having the same numerical aperture (NA) as in a digital versatile disc (hereinafter referred to as DVD in abbreviation) is used, it is possible to record information of 15-20 GB for an optical disc having diameter of 12 cm, and it is possible to record information of 23-27 GB for an optical disc having diameter of 12 cm, when NA of the objective lens is enhanced to 0.85. From now on, in the present specification, an optical disc and a magneto-optical disc both using a violet laser light source are called “high density optical disc” generically.

Incidentally, two standards are proposed presently as a high density optical disc. One of them is a blue ray disc (hereinafter, abbreviated as BD) that uses an objective lens with NA 0.85 and has a protective layer thickness of 0.1 mm, and the other is HD DVD (hereinafter, abbreviated as HD) that uses an objective lens with NA 0.65-0.67 and has a protective layer thickness of 0.6 mm. In view of consideration that these two types of high density optical discs each having a different standard may be on the market in the future, there is desired a high density optical disc player/recorder that is capable of conducting recording/reproducing for both of the aforesaid high density optical discs.

As a method of correcting aberration that is caused by a difference in a wavelength of a light flux and a thickness of a protective base board used for plural optical discs, there has been known a technology to change a degree of divergence of a light flux entering an objective optical system, or to provide a diffractive structure on an optical surface of an optical element constituting an optical pickup device (for example, see Patent Document 1).

(Patent Document 1) TOKKAI No. 2002-298422

However, the invention described in the Patent Document 1 is a technology to change a degree of divergence λ1 of a light flux entering an objective optical system as a method to correct aberration in the case of attaining compatibility between DVD and CD, and if this technology is used for attaining compatibility between high density optical discs, the high density optical disc has problems that an amount of generation of coma caused by lens shifting in the course of tracking is large and off-axial characteristic is greatly worsened, because a wavelength of a working light flux is short, NA is great and a difference between protective layer thicknesses is large, for the high density optical disc.

Further, there has been known a technology to attain compatibility between optical discs each having a different protective layer thickness, by making a conjugate length of an objective lens to be different, and if this technology is used for attaining compatibility between high density optical discs, a conjugate length ratio grows greater and tracking characteristics and magnification characteristics become problematic, for the high density optical disc, because a wavelength of a working light flux is short, NA is great and a difference between protective layer thicknesses is large.

Further, since a wavelength of a working light flux for BD is the same as that for HD, it is not possible to use a technology which has been known to attain compatibility between two types of optical discs by providing a diffractive structure on an objective lens or by arranging a liquid crystal element just in front of an objective lens, and thereby, by giving a phase difference that is different between BD and HD.

### DISCLOSURE OF THE INVENTION

Taking the aforesaid problems into consideration, an object of the invention is to provide an objective lens which can be used for two optical lenses each having a different protective layer thickness and a different standard, and to provide an optical pickup device employing the aforesaid objective lens.

To solve the aforesaid problems, the invention described in Item 1 is an objective lens for an optical pickup device conducting, at least, reproducing and/or recording of information for the first optical disc having protective base board thickness t1 (0 mm≦t1≦0.2 mm) by using a light flux having wavelength λ1 (370 nm≦λ1≦440 nm) and reproducing and/or recording of information for the second optical disc having protective base board thickness t2 (t1<t2) by using a light flux having wavelength λ1, wherein when an area representing a designated area on an optical surface of the objective lens in which the light flux with the wavelength λ1 passing through the area is used for conducting reproducing and/or recording of information for the first and second optical discs, is prescribed as a first zone, and when the third optical disc having protective base board thickness T (0.13 mm≦T≦0.25 mm) is assumed, the following expression is satisfied by value SA3 of 3^{rd} order spherical aberration that is generated when the light flux having the wavelength λ1 passing through the first zone after entering the objective lens to be in parallel with an optical axis is converged on an information recording surface of the third optical disc.
−0.01 λrms≦SA3≦0.01 λrms

By designing an objective lens and an optical pickup device so that value SA3 of 3^{rd} order spherical aberration generated by a parallel light flux with wavelength λ1 for the third optical disc arranged imaginarily may satisfy −0.01 λrms≦SA3≦0.01 λrms, namely, it may be zero, as in the invention described in Item 1, and by conducting reproducing and/or recording of information for the first optical disc and the second optical disc by the use of the aforesaid objective lens and optical pickup device, the spherical aberration generated by a difference from protective base board thickness T of the third optical disc results in a level which can be corrected by a liquid crystal element, for example, even in the case of the first optical disc and the second optical disc, resulting in that no problem is caused for lens shifting in tracking and for off-axial characteristic, and compatibility between the first optical disc and the second optical disc can be attained, even in the case where finite light is caused to enter the objective lens in the course of conducting recording and reproducing for the first and second optical discs, for correcting the spherical aberration to be substantially zero.

### BRIEF DESCRIPTION OF THE DRAWINGS

FIG. 1 is a top view of primary portions showing the structure of an optical pickup device.

FIG. 2 is a cross-sectional view of an objective lens.

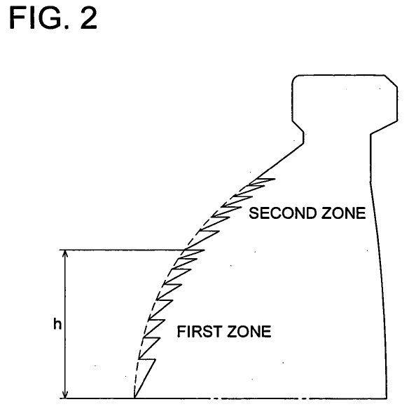

### BEST MODE FOR CARRYING OUT THE INVENTION

An embodiment preferable to attain the aforesaid object will be explained as follows.

The invention described in Item 2 is the objective lens according to Item 1, wherein the light flux having the wavelength λ1 enters the objective lens as convergent light, when conducting reproducing and/or recording of information for the first optical disc.

The invention described in Item 3 is the objective lens according to Item 2, wherein optical system magnification m1 of the objective lens in the case of conducting reproducing and/or recording of information for the first optical disc satisfies 1/100≦m1≦ 1/55.

The invention described in Item 4 is the objective lens according to any one of Items 1-3, wherein the light flux having the wavelength λ1 enters the objective lens as divergent light, when conducting reproducing and/or recording of information for the second optical disc.

The invention described in Item 5 is the objective lens according to Item 4, wherein optical system magnification m2 of the objective lens in the case of conducting reproducing and/or recording of information for the second optical disc satisfies − 1/15≦m2≦− 1/50.

As described in Item 2 up to Item 5, when conducting reproducing and/or recording of information for the first optical disc, the light flux having the wavelength λ1 enters the objective lens as convergent light, and the light flux having the wavelength λ1 enters the objective lens as divergent light, when conducting reproducing and/or recording of information for the second optical disc, thus, the 3^{rd} order spherical aberration can be made zero substantially.

The invention described in Item 6 is the objective lens according to any one of Items 1-5, wherein a first diffractive structure is provided on at least one optical surface of the objective lens, and the first diffractive structure has a positive diffracting power for the incident light flux having the wavelength λ1.

The invention described in Item 7 is the objective lens according to Item 6, wherein the first diffractive structure has a function to correct chromatic aberration of the light flux having the wavelength λ1 in the case of conducting reproducing and/or recording of information for the first and second optical discs.

It is possible to correct chromatic aberration of the light flux having wavelength λ1 in the case of conducting reproducing and/or recording of information for the first and second optical discs, by providing, on the optical surface of the objective lens, the first diffractive structure having the positive diffracting power for the incident light flux having wavelength λ1, as in the inventions in Item 6 and Item 7.

The invention described in Item 8 is the objective lens according to any one of Items 1-7, wherein focal length f of the objective lens for the light flux having wavelength λ1 satisfies 0.8 mm≦f≦3.5 mm.

The invention described in Item 9 is the objective lens according to any one of Items 1-8, wherein when the second area is represented by an area that is a prescribed area on the optical surface of the objective lens and is an area which is used for reproducing and/or recording of information for the first optical disc and is not used for reproducing and/or recording of information for the second optical disc, the second diffractive structure is provided on the second area, and B₄<0 holds when the second diffractive structure is expressed as in the following expression by the use of optical path difference function φ (h).
φ(h)=(B₂×h²+B₄×h⁴+ . . . +B₂ᵢ×h²ⁱ)×λ×n

In the aforesaid expression, h represents a height from an optical axis, B₂ᵢ represents a coefficient of the optical path difference function, i represents a natural number, λ represents a working wavelength and n represents an order of diffraction of diffracted light having the maximum diffraction efficiency among diffracted light of an incident light flux.

By making coefficient B₄<0 to hold, as in the invention described in Item 9, diffracted light with wavelength λ1 generated when passing through the second diffractive structure has a diffracting effect with a sign that is opposite to that of spherical aberration caused by lens material when a wavelength is changed, thus, spherical aberration characteristics in wavelength changes and temperature changes can be corrected. Since an amount of spherical aberration in the case of changes in a wavelength and temperature is proportional to the fourth power of NA, using this technology with BD having higher NA is effective. Further, even in the case where the second diffractive structure is provided in the area (for example, the first area mentioned above) through which the light flux used for HD also passes, spherical aberration characteristics in wavelength changes and temperature changes can be corrected in HD.

The invention described in Item 10 is the objective lens according to any one of Items 1-9, wherein a light flux having the wavelength λ1 used for conducting reproducing and/or recording of information for the first optical disc and a light flux having the wavelength λ1 used for conducting reproducing and/or recording of information for the second optical disc are emitted from the same light source.

The invention described in Item 11 is the objective lens according to Item 10, wherein the light source or at least one optical element arranged in an optical path from the light source to the objective lens is moved in the direction of an optical axis when conducting reproducing and/or recording of information for the first optical disc and the second optical disc.

The invention described in Item 12 is the objective lens according to Item 11, wherein the optical element is a coupling lens or a beam expander.

The invention described in Item 13 is the objective lens according to any one of Items 1-9, wherein a light flux having the wavelength λ1 used for conducting reproducing and/or recording of information for the first optical disc and a light flux having the wavelength λ1 used for conducting reproducing and/or recording of information for the second optical disc are emitted respectively from different light sources.

The invention described in Item 14 is the objective lens according to Item 13, wherein the light source emitting the light flux having the wavelength λ1 in the case of conducting reproducing and/or recording of information for the first optical disc is arranged to be farther from the objective lens in the optical axis direction than the light source emitting the light flux having the wavelength λ1 in the case of conducting reproducing and/or recording of information for the second optical disc is.

The invention described in Item 15 is the objective lens according to Item 13 or Item 14, wherein difference ΔL between optical distance L1 from the light source emitting a light flux with the wavelength λ1 in the case of conducting reproducing and/or recording of information for the first optical disc and optical distance L2 from the light source emitting a light flux with the wavelength λ1 in the case of conducting reproducing and/or recording of information for the second optical disc satisfies 4 mm≦ΔL≦6 mm.

Incidentally, the optical distance L is a distance (air-conversion distance) between a coupling lens wherein the wavefront aberration of the converged spot formed on an optical disc by the objective lens when an optical element does not exist between the coupling lens guiding light to the objective lens and a light source and the light source.

The invention described in Item 16 is the objective lens according to any one of Items 1-15, wherein the objective lens is composed of a single lens.

The invention described in Item 17 is characterized to be provided with the objective lens according to any one of Items 1-16.

The present invention makes it possible to obtain an objective lens which can be used for two types of high density optical discs each having a different protective layer thickness and a different standard and to obtain an optical pickup device employing the aforesaid objective lens.

In the present specification, in addition to the BD and HD mentioned above, an optical disc having, on its information recording surface, a protective layer whose thickness is several nanometers—several tens of nanometers and an optical disc wherein a thickness of a protective layer or a protective film is 0 (zero) are included in the high density optical disc.

In the present specification,

DVD is a generic name of optical discs in DVD series including DVD-ROM, DVD-Video, DVD-Audio, DVD-RAM, DVD-R, DVD-RW, DVD+R and DVD+RW, while, CD is a generic name of optical discs in CD series including CD-ROM, CD-Audio, CD-Video, CD-R and CD-RW.

A preferred embodiment for practicing the invention will be explained in detail as follows, referring to the drawings.

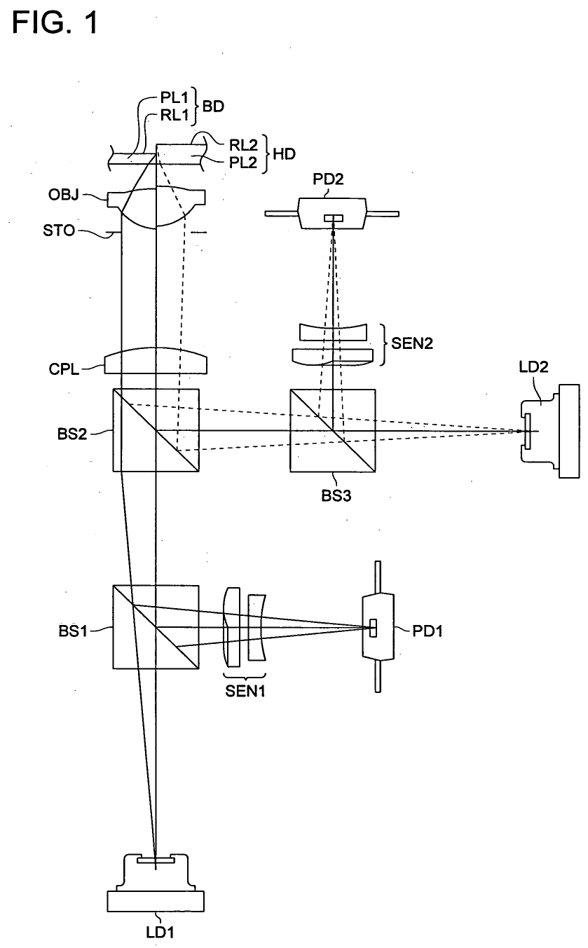

FIG. 1 is a diagram showing schematically the structure of optical pickup device PU capable of conducting recording and/or reproducing of information properly for two types of optical discs including BD (first optical disc) and HD (second optical disc) both representing a high density optical disc.

In the optical specifications of BD, wavelength λ1 is 407 nm, thickness t1 of protective layer (protective base board) PL1 is 0.1 mm and numerical aperture NA1 is 0.85, while, in the optical specifications of HD, wavelength λ1 is 407 nm, thickness t2 of protective layer (protective base board) PL2 is 0.6 mm and numerical aperture NA2 is 0.65.

However, the combination of the wavelength, the thickness of the protective layer and the numerical aperture is not limited to the foregoing mentioned above. It is further possible to use a high density optical disc having protective layer PL1 whose thickness t1 is about 0.1 mm, as the first optical disc.

Optical pickup device PU is composed of violet semiconductor laser LD1 (light source) for BD emitting a laser light flux having wavelength λ1 of 407 nm, violet semiconductor laser LD2 (light source) for HD emitting a laser light flux having wavelength λ1 of 407 nm, photodetector PD1 for BD, photodetector PD2 for HD, coupling lens CPL through which both a light flux for BD with wavelength λ1 and a light flux for HD with wavelength λ1 pass, objective lens OBJ having a function to converge light fluxes respectively on information recording surfaces RL1 and RL2, first beam splitter BS1, second beam splitter BS2, third beam splitter BS3, diaphragm STO, sensor lens SEN1 and sensor lens SEN2.

A structure of objective lens OBJ will be explained as follows.

An optical surface (a plane of incidence) facing a light source on the objective lens is divided into a first zone within a range of height h from an optical axis and a second zone that surrounds the first zone.

The first zone is a zone on the plane of incidence of the objective lens corresponding to numerical aperture NA2 (=0.65 of HD, and a light flux for HD having wavelength λ1 that has passed through the first zone is used for reproducing and/or recording of information for HD by forming a converged spot on information recording surface RL2 of HD. A light flux for BD having wavelength λ1 that has passed through the first zone is also used for reproducing and/or recording of information for BD by forming a converged spot on information recording surface RL1 of BD.

The second zone is a zone on the plane of incidence of the objective lens corresponding to a range from numerical aperture NA2 of HD to NA1 (=0.85) of BD, and a light flux for HD having wavelength λ1 that has passed through the second zone does not form a converged spot on information recording surface RL2 of HD, and is not used for reproducing and/or recording of information for HD. On the other hand, a light flux for BD having wavelength λ1 that has passed through the second zone forms a converged spot on information recording surface RL1 of BD, and is used for reproducing and/or recording of information for BD.

Then, a third optical disc having protective base board thickness T (0.13 mm≦T≦0.25 mm) is arranged imaginarily on the aforesaid optical pickup device PU, and an objective lens and an optical pickup device of the invention are designed so that −0.01 λrms≦SA3≦0.01 λrms may be satisfied by value SA3 of 3^{rd} order spherical aberration generated on an information recording surface of the third optical disc when the light flux with wavelength λ1 enters the first zone as a parallel ray.

The protective base board thickness T of the third optical disc is established so that its value may be one between BD protective base board thickness t1=0.1 mm and HD protective base board thickness t2=0.6 mm.

When the third optical disc that is not used practically in the actual pickup device is arranged imaginarily as mentioned above, and when the infinite parallel light having wavelength λ1 enters the objective lens, −0.01 λrms≦SA3≦0.01 λrms is satisfied by the value SA3 of 3^{rd} order spherical aberration of wavefront aberration on the third optical disc formed by the light flux passing the first zone.

The objective lens may be designed so that the component SA3 of 3^{rd} order spherical aberration is substantially zero in the imaginary optical system, and an optical pickup device representing the aforesaid optical system in the actual inspection may be provided newly, and it can be measured easily, if an infinite light arrangement is provided in an ordinary interferometer on the market. If the optical pickup device wherein a convergent light enters in the case of BD and a divergent light enters in the case of HD is designed, under the assumption that the objective lens of this kind is used, it is possible to restrain the component SA3 of 3^{rd} order spherical aberration to the level of no problem in practical use when each optical disc is used, and it is possible to attain compatibility between BD and HD.

When conducting recording and/or reproducing of information for BD, on the optical pickup device PU, violet semiconductor laser LD1 is first caused to emit light, as its light path is drawn with solid lines in FIG. 1. A divergent light flux emitted from the violet semiconductor laser LD1 passes through the first beam splitter BS1 and the second beam splitter BS2, to arrive at coupling lens CPL.

Then, when the light flux with wavelength λ1 for BD is transmitted through coupling lens CPL, an angle of divergence of the light flux is changed so that the light flux may enter the objective lens as a slight convergent light. Incidentally, it is preferable that optical system magnification m1 of the objective lens in this case is within a range of 1/100≦m1≦ 1/55, and focal length f of the objective lens is within a range of 0.8 mm≦f≦3.5 mm.

The light flux with wavelength λ1 for BD whose angle of divergence is changed by coupling lens CPL so that the light flux may become a slight convergent light is subjected to refracting actions when it passes through the first zone, the second zone on a plane of incidence and through a plane of emergence of the objective lens, and is converged on information recording surface RL1 through protective layer PL1 of BD, to form a spot.

The objective lens OBJ is subjected by biaxial actuator AC (not shown) arranged on the periphery of the objective lens to focusing and tracking. A reflected light flux modulated by information pits on information recording surface RL1 passes again through objective lens OBJ, coupling lens CPL and second beam splitter BS2, then, is branched by first beam splitter BS1, and is given astigmatism by sensor lens SEN1, to be converged on a light-receiving surface of photodetector PD1. Thus, information recorded on BD can be read by the use of signals outputted from photodetector PD1.

Further, when conducting recording and/or reproducing of information for HD, violet semiconductor laser LD2 is first caused to emit light, as its light path is drawn with dotted lines in FIG. 1. A divergent light flux emitted from the violet semiconductor laser LD2 passes through the third beam splitter BS3 and is reflected on the second beam splitter BS2 to arrive at coupling lens CPL.

Then, when the light flux with wavelength λ1 for HD is transmitted through coupling lens CPL, an angle of divergence of the light flux is changed so that the light flux may enter the objective lens as a slight divergent light. Incidentally, it is preferable that optical system magnification m2 of the objective lens in this case is within a range of − 1/15≦m2≦− 1/50.

The light flux with wavelength λ1 for HD whose angle of divergence is changed by coupling lens CPL so that the light flux may become a slight divergent light arrives at a plane of incidence of the objective lens, and the light flux which has passed through the first zone is subjected to refracting actions when it passes through the first zone and a plane of emergence, and is converged on information recording surface RL2 through protective layer PL2 of HD, to form a spot. However, the light flux which has passed through the second zone is not used for reproducing and/or recording of information for HD, because the light flux is subjected to refracting actions by the second zone and a plane of emergence not to form a converged spot on information recording surface RL2 of HD.

The objective lens OBJ is subjected by biaxial actuator AC (not shown) arranged on the periphery of the objective lens to focusing and tracking. A reflected light flux modulated by information pits on information recording surface RL2 passes again through objective lens OBJ and coupling lens CPL, then, is branched by second beam splitter BS2 and third beam splitter BS3, and is given astigmatism by sensor lens SEN2, to be converged on a light-receiving surface of photodetector PD2. Thus, information recorded on HD can be read by the use of signals outputted from photodetector PD2.

Meanwhile, it is also possible to provide a diffractive structure (first diffractive structure) having a positive diffracting power for the incident light flux with wavelength λ1 on an optical surface of the objective lens, and to correct chromatic aberration of the light flux with wavelength λ1 in the case of conducting reproducing and/or recording of information for BD and HD, by the use of the diffractive structure. Incidentally, an explanation of the technology to correct the chromatic aberration by using the diffractive structure will be omitted, because it is widely known.

It is further possible to provide a diffractive structure (second diffractive structure) on the second zone mentioned above.

The second diffractive structure is expressed by an optical path difference defined by the following optical path difference function φ (h) that is added to transmitted wave front by the second diffractive structure, and it is designed so that B₄<0 may hold when φ (h) is expressed as in the following expression.
φ(h)=(B₂×h²+B₄+h⁴+ . . . +B₂ᵢ×h²ⁱ)×λ×n

In the aforesaid expression, h represents a height from the optical axis, B₂ᵢ represents a coefficient of the optical path difference function, i represent a natural number, λ represents a working wavelength and n represents an order of diffraction of diffracted light having the maximum diffraction efficiency among diffracted light of an incident light flux.

By making the expression of coefficient B₄<0 to hold, diffracted light with wavelength λ1 generated when passing through the second diffractive structure has a diffracting effect with a sign that is opposite to that of spherical aberration caused by lens material when a wavelength is changed, thus, spherical aberration characteristics in wavelength changes and temperature changes can be corrected. Since an amount of spherical aberration in the case of changes in a wavelength and temperature is proportional to the fourth power of NA, using this technology with BD having higher NA is effective. Further, even in the case where the second diffractive structure is provided in the area (for example, the first area mentioned above) through which the light flux used for HD also passes, spherical aberration characteristics in wavelength changes and temperature changes can be corrected in HD.

In the present embodiment, there are provided separately violet semiconductor laser LD1 emitting a light flux with wavelength λ1 used for conducting reproducing and/or recording of information for the first optical disc and violet semiconductor laser LD2 emitting a light flux with wavelength λ1 used for conducting reproducing and/or recording of information for the second optical disc. However, the same light source may also be used, without being limited to the foregoing.

In this case, it is also possible to arrange a structure wherein an angle of divergence of the light flux that enters the objective lens is adjusted properly in accordance with a type of an optical disc for which reproducing and/or recording is conducted, by moving a light source itself or at least one optical element (for example, coupling lens CPL in FIG. 1) arranged in the optical path, in the optical axis direction.

Further, when violet semiconductor laser LD1 and violet semiconductor laser LD2 are arranged separately as in the embodiment stated above, it is preferable that the violet semiconductor laser LD1 is arranged to be farther from the objective lens in the optical axis direction than the violet semiconductor laser LD2 is, and in'this case, it is preferable that optical distance L from the violet semiconductor laser LD1 to the violet semiconductor laser LD2 satisfies 4 mm≦L≦6 mm.

### EXAMPLE

Next, an example of the objective lens shown in the aforesaid embodiment will be explained.

In the present example, an optical surface facing a light source on the objective lens representing a single lens is divided into a first zone (2^{nd} surface) whose height h from the optical axis satisfies 0 mm≦h≦2.01 mm and a second zone (2′^{th} surface) whose height h satisfies 2.01 mm<h, while, optical surfaces (2^{nd} surface and 2′^{th} surface) facing the light source on the objective lens and an optical surface (3^{rd} surface) facing an optical disc are formed to be axially symmetrical aspheric surfaces. This aspheric surface is expressed by an expression wherein aspheric surface coefficient in Table 1 or Table 2 is substituted in the following expression 1, when x (mm) represents an amount of transformation from a plane that is tangential to the vertex of the aspheric surface, h (mm) represents a height in the direction perpendicular to the optical axis and r (mm) represents a radius of curvature, in which x represents the conic constant.

$$x = \frac{{h}^{2} / r}{1 + \sqrt{1 - ( 1 + κ ) {( h / r )}^{2}}} + {\sum }_{i = 2} {A}_{2 i} {h}^{2 i} \qquad ( Numeral 1 )$$

Table 1 shows lens data of the objective lens in the First Example.

TABLE 1
First Example Lens data

| | | |
|---|---|---|
| Focal length of objective lens | f₁ = 3.0 mm | f₂ = 3.0 mm |
| Numerical aperture on image plane side | NA1: 0.85 | NA2: 0.65 |
| Magnification | m1: 1/64.1 | m2: −1/18.3 |
| Third optical disc base board thickness T | 0.18 mm | |

| | | | di (base | di (base |
|---|---|---|---|---|
| | | | board | board |
| i^{th} | | | thickness | thickness |
| surface | ri | ni | 0.1 mm) | 0.6 mm) |
| 0 | | | −192.50 | 55.00 |
| 1 | ∞ | | 0.1 (φ5.1 mm) | 0.1 (φ3.91 mm) |
| (Aperture | | | | |
| diameter) | | | | |
| 2 | 2.03440 | 1.524609 | 4.50 | 4.50 |
| 2′ | 2.04429 | 1.524609 | 0.008505 | 0.008505 |
| 3 | −1.66063 | 1.0 | 0.61 | 0.51 |
| 4 | ∞ | 1.618689 | 0.10 | 0.60 |
| 5 | ∞ | | | |

* The symbol di represents a displacement from i^{th} surface to (i + 1)^{th} surface.
* The symbol di′ represents a displacement from i^{th} surface to i^{th} surface.

Aspheric Surface Data
2^{nd} Surface (0 mm≦h≦2.01 mm)
Aspheric Surface Coefficient

κ −6.9077×E−1

A4 +3.517×E−3

A6 +4.575×E−5

A8 +7.555×E−5

A10 −3.9617×E−6

A12 −1.8216×E−6

A14 +3.3136×E−8

A16 +2.2576×E−7

A18 −4.7823×E−9

A20 +2.5858×E−9

2′^{th} Surface (2.01 mm<h≦2.6 mm)

Aspheric Surface Coefficient

κ −6.9544×E−1

A4 +2.6704×E−3

A6 +6.8305×E−5

A8 +8.7919×E−5

A10 −3.0759×E−7

A12 −1.2042×E−6

A14 +7.2818×E−8

A16 +2.8590×E−8

A18 −4.6867×E−9

A20 −2.1117×E−10

3^{rd} Surface

Aspheric Surface Coefficient

κ −1.7480×E+1

A4 +5.8840×E−2

A6 −4.4788×E−2

A8 +1.4592×E−2

A10 −1.9879×E−3

A12 +3.3483×E−5

As shown in Table 1, the objective lens of the First Example is established to have focal length f1=3.0 mm, magnification m1= 1/64.1 and image plane side numerical aperture NA1=0.85 under the condition of wavelength λ1=405 nm for BD, and to have focal length f2=3.0 mm, magnification m2=− 1/18.3 and image plane side numerical aperture NA2=0.65 under the condition of wavelength λ1=405 nm for HD.

In the First Example, when infinite collimated light enters the second surface of the objective lens (0 mm≦h≦2.01 mm), its light flux is converged on the base board of the third optical disc having base board thickness of 0.18 mm, and the third order spherical aberration component of the wavefront aberration of the converged spot is 0 λ. Meanwhile, wavefront aberration of the spot converged on BD (first optical disc) is 0.059 λ, and wavefront aberration of the spot converged on HD (second optical disc) is 0.004 λ.

Table 2 shows lens data of the objective lens of the Second Example.

TABLE 2
Second Example Lens data

| | | |
|---|---|---|
| Focal length of objective lens | f₁ = 3.0 mm | f₂ = 3.0 mm |
| Numerical aperture on image plane side | NA1: 0.85 | NA2: 0.65 |
| Magnification | m1: 1/100 | m2: −1/16.9 |
| Third optical disc base board thickness T | 0.14 mm | |

| | | | di (base | di (base |
|---|---|---|---|---|
| | | | board | board |
| i^{th} | | | thickness | thickness |
| surface | ri | ni | 0.1 mm) | 0.6 mm) |
| 0 | | | −300.00 | 50.66 |
| 1 | ∞ | | 0.1 (φ5.1 mm) | 0.1 (φ3.91 mm) |
| (Aperture | | | | |
| diameter) | | | | |
| 2 | 2.02801 | 1.524609 | 4.50 | 4.50 |
| 2′ | 2.04389 | 1.524609 | 0.010556 | 0.0010556 |
| 3 | −1.66185 | 1.0 | 0.63 | 0.52 |
| 4 | ∞ | 1.618689 | 0.0875 | 0.6000 |
| 5 | ∞ | | | |

* The symbol di represents a displacement from i^{th} surface to (i + 1)^{th} surface.
* The symbol di′ represents a displacement from i^{th} surface to i^{th} surface.

Aspheric Surface Data
2^{nd} Surface (0 mm≦h≦2.01 mm)
Aspheric Surface Coefficient

κ −6.9087×E−1

A4 +3.1500×E−3

A6 +3.7661×E−5

A8 +7.5789×E−5

A10 −3.8766×E−6

A12 −1.8268×E−6

A14 +2.6006×E−8

A16 +2.2399×E−7

A18 −4.6798×E−8

A20 +2.4751×E−9

2′^{th} Surface (2.01 mm<h≦2.6 mm)

Aspheric Surface Coefficient

κ −6.9445×E−1

A4 +2.6882×E−3

A6 +7.5107×E−5

A8 +8.9112×E−5

A10 −1.9371×E−7

A12 −1.2139×E−6

A14 +6.7943×E−8

A16 +2.7736×E−8

A18 −4.7639×E−9

A20 −1.9247×E−10

3^{rd} Surface

Aspheric Surface Coefficient

κ −1.7636×E+1

A4 +5.8849×E−2

A6 −4.4937×E−2

A8 +1.4628×E−2

A10 −1.9798×E−3

A12 +3.0912×E−5

As shown in Table 2, the objective lens of the Second Example is established to have focal length f1=3.0 mm, magnification m1= 1/100 and image plane side numerical aperture NA1=0.85 under the condition of wavelength λ1=405 nm for BD, and to have focal length f2=3.0 mm, magnification m2=− 1/16.9 and image plane side numerical aperture NA2=0.65 under the condition of wavelength λ1=405 nm for HD.

In the Second Example, when infinite collimated light enters the second surface of the objective lens (0 mm≦h≦2.01 mm), its light flux is converged on the base board of the third optical disc having base board thickness of 0.14 mm, and the third order spherical aberration component of the wavefront aberration of the converged spot is 0 λ. Meanwhile, wavefront aberration of the spot converged on BD is 0.037 λ, and wavefront aberration of the spot converged on HD is 0.004 λ.

1. An objective lens for an optical pickup device conducting at least reproducing and/or recording of information for a first optical disc having a protective base board thickness t1 (0 mm≦t1≦0.2 mm) by using a light flux having a wavelength λ1 (370 nm≦λ1≦440 nm) and reproducing and/or recording of information for a second optical disc having a protective base board thickness t2 (t1<t2) by using a light flux having a wavelength λ1, comprising:
a first zone defined as an area representing a designated area on an optical surface of the objective lens in which a light flux with the wavelength λ1 passing through the area is used for conducting reproducing and/or recording of information for the first and second optical discs,
wherein when a third optical disc having a protective base board thickness T (0.13 mm≦T≦0.25 mm) is assumed, a 3^{rd} order spherical aberration value SA3 that is generated when a light flux having the wavelength λ1 passing through the first zone after entering the objective lens to be in parallel with an optical axis is converged on an information recording surface of the third optical disc, satisfies the following expression.
−0.01 λrms≦SA3≦0.01 λrms

2. The objective lens according to claim 1, wherein when conducting reproducing and/or recording of information for the first optical disc, the light flux having the wavelength λ1 enters the objective lens as convergent light.

3. The objective lens according to claim 2, wherein optical system magnification m1 of the objective lens in the case of conducting reproducing and/or recording of information for the first optical disc satisfies 1/100≦m1≦ 1/55.

4. The objective lens according to claim 1, wherein the light flux having the wavelength λ1 enters the objective lens as divergent light, when conducting reproducing and/or recording of information for the second optical disc.

5. The objective lens according to claim 4, wherein optical system magnification m2 of the objective lens in the case of conducting reproducing and/or recording of information for the second optical disc satisfies − 1/15≦m2≦− 1/50.

6. The objective lens according to claim 1, wherein the first diffractive structure is provided on at least one optical surface of the objective lens, and the first diffractive structure has a positive diffracting power for the incident light flux having the wavelength λ1.

7. The objective lens according to claim 6, wherein the first diffractive structure has a function to correct chromatic aberration of the light flux having the wavelength λ1 in the case of conducting reproducing and/or recording of information for the first and second optical discs.

8. The objective lens according to claim 1, wherein focal length f of the objective lens for the light flux having wavelength λ1 satisfies 0.8 mm≦f≦3.5 mm.

9. The objective lens according to claim 1, wherein when an area that is a designated area on an optical surface of the objective lens and is an area utilized for conducting reproducing and/or recording of information for the first optical disc for the light flux with wavelength λ1 which has passed through the area and is not utilized for conducting reproducing and/or recording of information for the second optical disc, is prescribed as a second zone, the second diffractive structure is provided on the second zone, and B₄<0 holds when the second diffractive structure is expressed as
φ(h)=(B₂×h²+B₄×h⁴+ . . . +B₂ᵢ×h²ⁱ)×λ×n
by using optical path difference function φ (h).
In the aforesaid expression, h represents a height from an optical axis, B₂ᵢ represents a coefficient of the optical path difference function, i represents a natural number, λ represents a working wavelength and n represents an order of diffraction of diffracted light having the maximum diffraction efficiency among diffracted light of an incident light flux.

10. The objective lens according to claim 1, wherein a light flux having the wavelength λ1 used for conducting reproducing and/or recording of information for the first optical disc and a light flux having the wavelength λ1 used for conducting reproducing and/or recording of information for the second optical disc are emitted from the same light source.

11. The objective lens according to claim 10, wherein the light source or at least one optical element arranged in an optical path from the light source to the objective lens is moved in the direction of an optical axis when conducting reproducing and/or recording of information for the first optical disc and the second optical disc.

12. The objective lens according to claim 11, wherein the optical element is a coupling lens or a beam expander.

13. The objective lens according to claim 1, wherein a light flux having the wavelength λ1 used for conducting reproducing and/or recording of information for the first optical disc and a light flux having the wavelength λ1 used for conducting reproducing and/or recording of information for the second optical disc are emitted respectively from different light sources.

14. The objective lens according to claim 13, wherein the light source emitting the light flux having the wavelength λ1 in the case of conducting reproducing and/or recording of information for the first optical disc is arranged to be farther from the objective lens in the optical axis direction than the light source emitting the light flux having the wavelength λ1 in the case of conducting reproducing and/or recording of information for the second optical disc is.

15. The objective lens according to claim 14, wherein difference ΔL between optical distance L1 from the light source emitting a light flux with the wavelength λ1 in the case of conducting reproducing and/or recording of information for the first optical disc and optical distance L2 from the light source emitting a light flux with the wavelength λ1 in the case of conducting reproducing and/or recording of information for the second optical disc satisfies 4 mm≦ΔL≦6 mm.

16. The objective lens according to claim 1, wherein the objective lens is composed of a single lens.

17. An optical pickup device equipped with the objective lens described in claim 1.
